(19) United States
(12) Patent Application Publication
(10) Pub. No.: US 2022/0395020 A1
(43) Pub. Date: Dec. 15, 2022

(54) METHOD FOR PRODUCING A CONICAL FILTER BODY

(71) Applicant: VAUEN Adolf Eckert GmbH & Co. KG, Nurnberg (DE)

(72) Inventor: Martin Ramsauer, Nurnberg (DE)

(73) Assignee: VAUEN Adolf Eckert GmbH & Co. KG, Nurnberg (DE)

(21) Appl. No.: 17/776,936

(22) PCT Filed: Sep. 21, 2021
(86) PCT No.: PCT/EP2021/075946

§ 371 Date: May 13, 2022

(30) Foreign Application Priority Data
Sep. 22, 2020 (DE) 10 2020 124 718.4

(51) Int. Cl. A24D 3/02; A24D 3/04; A24D 3/06

(52) U.S. Cl. CPC A24D 3/0245; A24D 3/048; A24D 3/0283; A24D 3/061

(57) ABSTRACT

A method of manufacturing a conical filter body (1) for a conical smokable product filter, comprising the following steps:
Providing a band-like or -shaped filed body material (3)
Cutting out at least one blank (4) of predefined geometry from the band-like or -shaped filter body material (3),
Connecting at least two sections (4.1, 4.2) of the at least one black (4) to form a conical filter body (1).

The invention relates to a method for producing a conical filter body for a conical filter of a smokable product.

Methods for producing conical filter bodies for conical filters of smokable products, such as cannabis cigarettes, which are commonly also referred to as “joints”, as well as methods for producing conical filters for smokable products, are known in principle from the prior art.

For example, DE 103 41 242 A1 describes a method for producing a conical filter for smokable products which includes providing a conical lateral body, which is closed at one end by an end element, inserting a filter material into the conically shaped interior space in the lateral body, and closing the interior space by pressing, bonding or snapping in an end element.

The principles known from the prior art for producing corresponding conical filter bodies are worthy of improvement in particular in respect of production that is efficient from both a manufacturing and an economic standpoint.

The invention addresses the problem of providing a method that is improved compared with the above for producing a conical filter body for a conical filter of a smokable product.

The problem is solved by a method for producing a conical filter body for a conical filter of a smokable product according to claim 1. The claims that are dependent thereon relate to possible embodiments of the method.

A first aspect of the invention relates to a method for producing a conical filter body for a conical filter of a smokable product. A corresponding smokable product may e.g. be understood to be a cannabis cigarette, which is commonly also referred to as a “joint”, or other tobacco products that can be consumed in an identical or similar way. In particular, reference is made to those smokable products which are intended for rolling, i.e. which are provided with smoking consumables, such as tobacco or the like, by a user. A conical filter body that is or can be produced according to the method typically has a sleeve-like or sleeve-shaped three-dimensional conical basic shape, such that a filter body that is or can be produced according to the method can also be referred to or considered as a filter sleeve.

According to the method, filter bodies may e.g. be produced that have a length or height of max. 50 mm, in particular max. 40 mm, more particularly max. 30 mm, a minimum internal diameter of 5 mm, a maximum internal diameter of 10 mm, and a maximum cone angle in a range between 2 and 5°, in particular of 3°. Of course, filter bodies having other geometric parameters can also be produced in principle.

The method comprises the following steps, which are described in greater detail in the following:

In a first step of the method, a strip-like or strip-shaped filter body material is provided. In the first step of the method, a strip-like or strip-shaped filter body material, referred to in the following as the “filter body material” for short, is therefore provided. The filter body material may be provided continuously, semi-continuously or discontinuously.

For example, the filter body material may be a paper, in particular a filter paper. The paper may have a certain absorbency. It is conceivable for a filter body material to be used which is provided with perforations, i.e. in general with weakened points, in order to facilitate particularly simple and exact separation and therefore the formation of blanks, which are described in greater detail below.

The filter body material can be provided by means of a provision apparatus, which can form a part of a device used for carrying out the method. The provision apparatus may be designed as a rolling, spooling or wrapping body or may comprise at least one such body, such that the filter body material can be unrolled, unspooled or unwrapped from a corresponding rolling, spooling or wrapping body, in particular at a statically or dynamically variable speed. The filter body material may accordingly be provided as continuous material that is rolled, spooled or wrapped onto a corresponding rolling, spooling or wrapping body. In general, the filter body material may be provided in an automated manner.

In a second step of the method, at least one blank having a predefined geometry is separated from the provided filter body material. In the second step of the method, at least one blank having a predefined geometry, referred to in the following as a “blank” for short, is therefore separated from the provided filter body material. The separation of corresponding blanks, which can be carried out in one or more separation steps, can be carried out continuously, semi-continuously or discontinuously. A predefined geometry of a blank prefabricated by a corresponding separation process is generally understood to be a geometry from which a three-dimensional cone or truncated cone can be formed, e.g. by rolling, spooling or wrapping. In particular, strip-like or strip-shaped geometries come into consideration, since a three-dimensional cone can be formed therefrom comparatively easily.

The at least one blank can be separated by means of a separation apparatus, which can form a part of a device used for carrying out the method. The separation apparatus may e.g. be designed as a mechanical separation apparatus, i.e. a cutting or stamping apparatus, for example, or an optical separation apparatus, i.e. a laser-cutting apparatus, for example, or may comprise at least one such apparatus. The at least one blank can therefore be separated from the filter body material e.g. by means of a mechanical separation process, in particular a cutting or stamping process, and/or by means of an optical separation process, in particular a laser-cutting process. The speed of the separation process is typically adapted to the speed of the provision process. In general, the at least one blank may be separated in an automated manner.

In the second step, a plurality of blanks are typically separated from the filter body material simultaneously or in succession, such that there are typically a plurality of blanks after the second step.

In a third step of the method, the at least one blank is connected to form a conical filter body, wherein at least two, e.g. punctiform or linear, portions or regions of the at least one blank are typically connected to form a conical filter body. In the third step of the method, at least two portions of the at least one blank are therefore typically interconnected to form a three-dimensional conical or frustoconical filter body. The respective portions of corresponding blanks can be connected continuously, semi-continuously or discontinuously. During the connection of the at least two portions, the relevant blank is brought from its original spatial form, i.e. typically a (substantially) two-dimensional spatial form, into a three-dimensional conical spatial form. Corresponding portions of a relevant blank may in principle be any surface portions of the relevant blank. In particular, corresponding portions may be free ends of a relevant blank that are opposite one another, or corresponding portions may be arranged in the region of opposite free ends of the relevant blank, with a strip-like or strip-shaped basic shape of the short opposite ends in particular. As is clear from the following, the connection of respective portions of the at least one blank may also include form-fitting and/or force-locked and/or material-bonded fixing of the blank brought into a corresponding three-dimensional conical spatial form and therefore fixing of the cone geometry of the formed conical filter body in question.

The at least two portions of the at least one blank can be connected by means of a connecting apparatus, which can form a part of a device used for carrying out the method. The connecting apparatus may e.g. be formed as a wrapping apparatus or may comprise at least one such apparatus. As explained in greater detail below, the filter body may therefore in particular be formed by rolling or wrapping at least one relevant blank once or multiple times onto a wrapping body, wherein the at least two portions of the relevant blank are likewise interconnected. The speed of the connection of the at least two portions of a relevant blank to form a conical filter body may be adapted to the speed of the provision process and/or to the speed of the separation process. In general, the at least two portions of a relevant blank may be connected to form a conical filter body in an automated manner.

In the third step, a plurality of conical filter bodies may be formed simultaneously or in succession, such that there may be a plurality of filter bodies after the third step.

The method therefore provides a principle for producing conical filter bodies that can be presented as being extremely efficient because it can be (fully) automated, which principle takes a provided filter body material as a starting point, from which one or more blanks are separated, by means of corresponding separation processes, such as cutting or stamping processes, from which blanks conical filter bodies are then formed. As mentioned, the steps of the method can be carried out continuously, semi-continuously or discontinuously, such that a customised degree of automation and productivity can be implemented.

Overall, an improved method for producing conical filter bodies is provided.

As mentioned, in the second step, blanks having strip-like or strip-shaped geometries, i.e. generally having elongate geometries, can in particular be separated from the filter body material, since three-dimensional cones can be formed from these geometries comparatively easily. Blanks having curve-like or curved basic shapes, i.e. generally blanks having parabola-like or parabolic basic shapes, are particularly preferred here. A corresponding blank therefore preferably has a curve-like or curved basic shape, which simplifies the formation of a conical filter body by accordingly connecting at least two portions of the blank. Therefore, in the second step, blanks having curve-like or curved basic shapes are preferably separated from the filter body material. A curve-like or curved basic shape does not necessarily have to be limited to a simple curve; multiple curves are also conceivable, which can result in an undulating basic shape of a corresponding blank.

As mentioned, the at least two portions of a relevant blank can be connected by the blank being wrapped around a wrapping body. Typically, a wrapping body is used which has an axis of symmetry or a central axis about which it can be rotatably mounted. A conical wrapping body is preferably used which reproduces the geometry of the filter body to be produced. A corresponding blank can therefore be wrapped around a conical wrapping body once or multiple times, and therefore wrapped onto a corresponding wrapping body, as a result of which the blank is brought into the three-dimensional conical spatial form.

According to the method, a wrapping body comprising a fixing apparatus, which optionally also forms a part of a device used to carry out the method, can be used as part of a wrapping process for, in particular mechanically and/or pneumatically, temporarily fixing a relevant blank. Therefore, a corresponding blank can be temporarily fastened during a wrapping process, and this makes it easier to bring the blank into the three-dimensional conical spatial form. The fixing apparatus may be configured for fastening a corresponding blank at one or more points, or optionally even over its (full) surface. Mechanical fixing of a blank may e.g. be implemented by one or more, e.g. slot-like or slot-shaped, cut-outs in a corresponding wrapping body, by means of which a blank can be temporarily fixed, in particular by a short side, e.g. by being inserted. Pneumatic fixing of a blank may e.g. be implemented by one or more vacuum openings in a corresponding wrapping body, by means of which a blank can be temporarily fastened, in particular by a short side, e.g. by suction. In all cases, temporary fixing may also include temporary fixing of the blank in an orientation that is desired for bringing said blank into the three-dimensional conical spatial form.

As mentioned, the connection of respective portions of a corresponding blank may also include material-bonded fixing of the blank brought into a corresponding three-dimensional conical spatial form and therefore fixing of the cone geometry of the formed filter body in question. Before connecting the at least two portions of a corresponding blank, i.e. in particular before being rolled or wrapped onto a wrapping body, at least one adhesive material, such as an adhesive, glue, etc., can therefore be applied to the blank. The adhesive material applied in individual dots and/or lines e.g. to the, or in the region of the, short sides of a blank having a curve-like or curved basic shape may require material-bonded fixing of the blank brought into a corresponding three-dimensional conical spatial form and therefore fixing of the cone geometry of the formed filter body in question.

A corresponding material-application apparatus may be arranged downstream of the above-mentioned mechanical processing apparatus and therefore the provision apparatus.

The operation of a corresponding material-application apparatus can be synchronised with the operation of a marking or printing apparatus of the device, as mentioned below, such that corresponding material-application processes and marking or printing processes can be synchronised. This may e.g. be advantageous for preventing any undesired interaction between respective adhesive material and marking or printing materials.

After separating corresponding blanks, the filter body material may be collected in a collection apparatus, with the filter body material then typically having a structure provided with cut-outs arranged in a grid-like or grid-shaped manner. The collection apparatus, which optionally likewise forms a part of a device used for carrying out the method, may e.g. be designed as a rolling, spooling or wrapping body or may comprise at least one such body, such that, after separating corresponding blanks, the filter body material can be collected on a corresponding wrapping body, e.g. by being rolled, spooled or wrapped, and can then either be disposed of or fed to a third or subsequent process.

As also mentioned, a plurality of blanks can be separated from the filter body material simultaneously or in succession. The blanks can be brought into their three-dimensional conical spatial form entirely simultaneously or in succession. It is, however, also conceivable for the blanks to first be temporarily collected in an, e.g. (revolver) magazine-like or (revolver) magazine-shaped, collection apparatus before the blanks are brought into their three-dimensional conical spatial form. Previously temporarily collecting the blanks may e.g. be advantageous because the blanks can again be brought into an orientation and/or position that is expedient for the connection and can optionally be stabilised before their respective portions are connected.

In this connection, but not so as to be limited thereto in principle, it should be mentioned that a plurality of blanks can be simultaneously connected, e.g. by means of a plurality of connecting apparatuses, i.e. in particular wrapping bodies, arranged so as to be connected in parallel and can thus be brought into their three-dimensional conical spatial form. This is a particularly efficient variant of the method.

Before separating corresponding blanks from the filter body material, the filter body material can be marked, in particular printed. Alternatively or additionally, after separating corresponding blanks from the filter body material, the blanks can be marked, i.e. in particular printed. Said filter body material or blanks can be marked or printed by means of a marking or printing apparatus, which can optionally likewise form a part of a device used for carrying out the method. A corresponding marking or printing apparatus may e.g. be formed as an embossing or inkjet-printer apparatus or may comprise at least one such apparatus. Likewise, an already marked, i.e. in particular printed, filter body material may be used as the starting material.

A second aspect of the invention relates to a filter body, which is characterised in that it has been produced according to the method according to the first aspect. All the embodiments relating to the method according to the first aspect apply by analogy to the filter body according to the second aspect.

A third aspect of the invention relates to a device for producing a conical filter body. The device is in particular configured for carrying out the method according to the first aspect of the invention. All the embodiments relating to the method according to the first aspect apply by analogy to the device according to the third aspect.

The device in particular comprises a provision apparatus for providing at least one strip-like or strip-shaped filter body material, in particular in an automatable or automated manner, a separation apparatus for separating at least one blank, in particular in an automatable or automated manner, from the filter body material provided by means of the provision apparatus, and a connecting apparatus for connecting at least two portions of the at least one blank, in particular in an automatable or automated manner, to form one or more filter bodies.

The provision apparatus may be designed as a rolling, spooling or wrapping body or may comprise at least one such body.

In particular, the provision apparatus may comprise a plurality of rolling, spooling or wrapping bodies, by means of which a strip-like or strip-shaped filter body material can be provided in each case. In this way, it is possible to provide a filter body material either via a first or a second rolling, spooling or wrapping body. Interruptions to the operation of the device caused by changing or replacing a rolling, spooling or wrapping body can therefore be considerably reduced. The provision apparatus may comprise an, e.g. frame-like or frame-shaped, mounting apparatus, by means of which a plurality of rolling, spooling or wrapping bodies can be mounted.

The device may further comprise at least one mechanical processing apparatus, arranged downstream of the provision apparatus, which is configured for mechanically processing at least portions of the strip-like or strip-shaped filter body material unwrapped from a rolling, spooling or wrapping body. The mechanical processing is carried out with the aim of preparing the filter body material for subsequent process steps, such as material-application steps, connection steps, etc. Specifically, a corresponding mechanical processing apparatus may e.g. be designed as a grinding apparatus or may comprise at least one such apparatus, which is configured for grinding and thus roughening the filter body material fed thereto in edge regions that are at the sides in the conveying or feed direction; corresponding side edge regions may take up e.g. 0.1-1.5 mm, based on the dimensions of the filter body material in the transverse extension. In order for it to be possible to accordingly mechanically process both side edge regions of the filter body material, a first mechanical processing apparatus may be provided for mechanically processing a first edge region of the filter body material and a second mechanical processing apparatus may be provided for mechanically processing a first edge region of the filter body material, e.g. in a paired arrangement.

The at least one mechanical processing apparatus may likewise be arranged on the mounting apparatus of the provision apparatus.

The separation apparatus may e.g. be designed as a mechanical separation apparatus, i.e. a cutting or stamping apparatus, for example, or an optical separation apparatus, i.e. a laser-cutting apparatus, for example, or may comprise at least one such apparatus. A corresponding cutting or stamping apparatus may comprise one or more cutting or stamping elements, such as cutting or stamping punches. Corresponding cutting or stamping elements may be ground at an angle in a range between 1 and 10°, in particular between 3 and 7°. In this way, a silhouette can be produced, which can reduce the separation forces required.

A corresponding separation apparatus may comprise a plurality of separate separation elements for carrying out different separation processes, i.e. a pre-separation step and a main separation step, for example. For the implementation as a cutting or stamping apparatus, the separation apparatus can therefore comprise one or more cutting or stamping elements for carrying out different cutting or stamping processes, i.e. in particular a pre-cutting step or pre-stamping step, and one or more cutting or stamping elements for carrying out a main cutting step or main stamping step.

A corresponding separation apparatus may in particular be configured for separating a plurality of blanks, i.e. in particular left and right blanks, from the strip-like or strip-shaped filter body material in one stroke, which blanks can, furthermore, be fed to separate wrapping apparatuses as part of the connecting apparatus.

A transfer apparatus may be assigned to the separation apparatus and/or the or a corresponding relocation apparatus, which transfer apparatus is configured for transferring one or more blanks generated in the separation apparatus from the separation apparatus to a relocation apparatus arranged downstream thereof. A corresponding transfer apparatus may comprise one or more transfer bodies, which each comprise a receiving or mounting region for receiving or mounting at least one blank. A corresponding receiving or mounting region may e.g. be formed by one or more exposed surface portions of a corresponding transfer body.

A corresponding transfer body may be mounted so as to be movable on at least one movement path into a first orientation and/or position, which can also be referred to as a receiving orientation and/or position, in which it is possible to receive at least one corresponding blank from the separation apparatus, and into a second orientation and/or position, which can also be referred to as a passing orientation and/or position, in which it is possible to pass a corresponding blank to the or a relocation apparatus, i.e. in particular to a corresponding relocation module of a corresponding relocation apparatus. A blank held by means of a corresponding transfer body can therefore be passed to a corresponding relocation module of the or a relocation apparatus in the passing orientation and/or position. In particular, a blank held by means of a corresponding transfer body can be passed along on corresponding bar-like or bar-shaped relocation elements of a corresponding relocation module of the or a relocation apparatus in the passing orientation and/or position. Corresponding bar-like or bar-shaped relocation elements of a relocation module can engage in a contoured surface of a corresponding transfer body formed by corresponding receiving contours, such as depressions, in the passing orientation and/or position of the transfer body, and this makes it possible to pass a corresponding blank particularly securely from a transfer body to the relocation module.

A corresponding transfer body may therefore comprise a contoured surface formed by receiving contours. The receiving contours are arranged and oriented such that, in the passing orientation and/or position of the transfer body, they align with corresponding bar-like or bar-shaped relocation elements of a relocation module of a relocation apparatus, such that said elements can engage in the receiving contours of the transfer body.

The respective drives of the transfer body and a corresponding relocation apparatus can therefore be coordinated with one another, e.g. by synchronisation, such that a corresponding receiving contour of a corresponding transfer body and a blank held by means of the transfer body are arranged or oriented in the passing orientation and/or position so as to be adjacent to one another or aligned with one another such that the blank can be passed to the relocation module of the relocation apparatus.

A corresponding transfer body may in particular be mounted so as to be movable on a plurality of movement paths or degrees of freedom. These may be translational degrees of freedom in one or more translations axes and/or rotational degrees of freedom in one or more rotational axes. Movements in combined degrees of freedom are conceivable here. In a specific embodiment, a corresponding transfer body can be moved out of the separation apparatus towards the relocation apparatus in at least one translational degree of freedom in at least one translational axis. A rotational movement may be superimposed on this translational movement. The movements can serve to correctly orient a corresponding blank in terms of it being passed to the relocation apparatus. In addition, a corresponding transfer body may be mounted in another translation axis for producing stroke movements, for example in order to correctly receive a corresponding blank in the separation apparatus.

It should also be mentioned here that respective movement paths for moving a corresponding transfer body from the first orientation and/or position into the second orientation and/or position may be identical to or different from movements of the transfer body from the second orientation and/or position into the first orientation and/or position.

In all the embodiments, a corresponding transfer body may comprise one or more flow ducts, which communicate with a flow-generating apparatus generating a suction flow and open into flow openings, via which it is possible to pneumatically hold a corresponding blank at least temporarily, in particular during a movement of the transfer body from a first orientation and/or position into a second orientation and/or position. In order to detach the blank from the transfer body in connection with passing a corresponding blank from a corresponding transfer body to a corresponding relocation apparatus, the or an additional flow-generating apparatus can be configured to generate a blowing flow, at least briefly and as required. The blowing flow can be implemented by a jet of compressed air, for example.

A corresponding transfer apparatus may comprise a plurality of corresponding transfer bodies, such that one or more first transfer bodies can be oriented and/or positioned to receive one or more blanks from the separation apparatus, and one or more second transfer bodies can simultaneously be oriented and/or positioned to pass one or more blanks to a corresponding relocation apparatus.

A corresponding transfer apparatus may be an example of a conveying or passing apparatus which is arranged between the separation apparatus and the relocation apparatus and by means of which blanks generated in the separation apparatus can be passed from the separation apparatus to the relocation apparatus.

The connecting apparatus may e.g. be formed as a wrapping apparatus or may comprise at least one such apparatus. The wrapping apparatus may comprise at least one, e.g. conical, wrapping body. The wrapping apparatus may comprise a fixing apparatus for, in particular mechanically and/or pneumatically, temporarily fixing a relevant blank as part of a wrapping process. The fixing apparatus may be configured for fastening a corresponding blank at one or more points, or optionally even over its (full) surface.

A corresponding conical wrapping body is typically mounted so as to be rotatable about its axis of symmetry in at least one rotational direction in order to carry out a corresponding wrapping process for forming a conical filter body from a corresponding blank. An e.g. (electro)motive or pneumatic drive may be assigned to the conical wrapping body for this purpose, by means of which drive the conical wrapping body can be set into a corresponding rotational movement.

The conical wrapping body may be provided with at least one receiving contour, e.g. formed by a groove, a slot or another cut-out, for receiving portions of a blank, i.e. in particular a short end of a blank. A corresponding receiving contour of a conical wrapping body may be oriented so as to extend coaxially with the axis of symmetry of the conical wrapping body. A corresponding receiving contour may optionally constitute a part of a fixing apparatus for mechanically and/or pneumatically temporarily fixing a relevant blank as part of a wrapping process.

A stabilising apparatus for stabilising a corresponding blank during a wrapping process may be assigned to the connecting apparatus, i.e. in particular a corresponding wrapping apparatus. A corresponding stabilising apparatus may therefore be configured in particular for generating forces stabilising a corresponding blank during a wrapping process; here, these are typically forces acting radially relative to the axis of symmetry of the conical wrapping body. Corresponding forces ensure that a corresponding blank lies on a corresponding conical wrapping body as desired and, associated therewith, ensures a desired geometry or volume of the conical filter body that has been produced or is to be produced.

A corresponding stabilising apparatus may therefore be designed as or comprise a pressure apparatus. A corresponding pressure apparatus may comprise at least one, e.g. plate-like or plate-shaped, pressure element. The at least one pressure element may be arranged or oriented in parallel with the conically extending outer geometry of the conical wrapping body in order to allow for the most extensive possible pressure. The at least one pressure element may be movable into at least one pressure position, in which it makes it possible to press a corresponding blank against the conical wrapping body. Specifically, for this purpose, a corresponding pressure element may be mounted so as to be movable in at least one translational and/or rotational degree of freedom. A corresponding pressure position can be maintained by further movements of the pressure element during the wrapping process, such that it is ensured that the pressure element lies on the blank throughout the entire wrapping process.

Movements of the at least one pressure element may be synchronised with movements of the relocation module and/or movements of the conical wrapping body, in order to make it possible to press against a corresponding blank immediately after receiving the blank in the receiving contour of the conical wrapping body and therefore right at the start of a wrapping process.

The device further comprises an application apparatus for applying an adhesive material to at least one blank before connecting the at least two portions of a corresponding blank. The application apparatus may comprise at least one, e.g. nozzle-like or nozzle-shaped, application element. The at least one application element may be mounted so as to be movable in at least one degree of freedom. The at least one application element may be configured for applying a corresponding adhesive material, i.e. a glue, for example, in a punctiform or strip-shaped manner to at least one corresponding blank. The at least one application element may therefore be configured for applying a corresponding adhesive material discontinuously, semi-continuously or continuously to at least one corresponding blank. It is applicable to all the variants that a corresponding adhesive material is or can be applied in particular to the short side of a corresponding blank.

The device may further comprise a collection apparatus for collecting the filter body material after the corresponding blanks have been separated. The collection apparatus may e.g. be designed as a rolling, spooling or wrapping body or may comprise at least one such body.

The device may further comprise a marking or printing apparatus for marking, in particular printing, the filter body material and/or corresponding blanks. The marking or printing apparatus may e.g. be formed as an embossing or inkjet-printer apparatus or may comprise at least one such apparatus.

A corresponding marking or printing apparatus may be arranged downstream of the above-mentioned mechanical processing apparatus and therefore the provision apparatus. If the device comprises a plurality of corresponding marking or printing apparatuses, they can be arranged centrally and/or to the side relative to the transverse direction of the fed filter body material in order to apply corresponding markings or printing to the filter body material centrally and/or to the side.

At this point, it should be generally noted that the device may comprise one or more position-detecting apparatuses at one or more positions, by means of which the orientation and/or position of the filter body material and subsequently corresponding blanks can be detected relative to a reference orientation and/or position, i.e. in particular a target orientation and/or position. Corresponding position-detecting apparatuses, which are e.g. implemented by optical apparatuses, such as cameras, barriers, etc., may be in data communication with positioning apparatuses for changing or adjusting the orientation and/or position of the filter body material conveyed through the device, such that potential deviations in the orientation and/or position of the filter body material from a corresponding reference orientation and/or position, i.e. in particular a target orientation and/or position, can be compensated for. By corresponding position-detecting apparatuses and positioning apparatuses interacting in this way, a sheet-edge control apparatus can be implemented for centring the filter body material.

It is applicable to all the embodiments of the device that the conveying speed of the filter body material through the control apparatus of the device can be changed where necessary in portions in a targeted manner. The control apparatus of the device can therefore communicate with one or more controllers of the conveying apparatus of the device to transmit control information in order to change the conveying speed of the filter body material in portions. For example, the control apparatus can be configured, in a corresponding manner, for changing, i.e. in particular for reducing the conveying speed of the filter body material upstream of, in particular immediately upstream of, the separation apparatus, in order to account for the cycle time of the separation process. Therefore, the feed motion, i.e. in particular the feed-motion speed, of the filter body material into the separation apparatus may e.g. be different from, i.e. greater than, the feed motion, i.e. in particular the feed-motion speed, of the filter body material as far as the separation apparatus.

It is applicable to all the embodiments of the device that all the mechanically movable or moved parts of individual, multiple or all the apparatuses of the device can be coupled indirectly or directly to a central drive element of the device. A corresponding central drive element may e.g. be formed by a main shaft or vertical shaft, which can be driven by a central (electro)motive drive unit of the device.

A corresponding central drive element may in particular be coupled to the above-mentioned separation apparatus and/or a or the transfer apparatus and/or a or the relocation apparatus and/or a or the wrapping apparatus of the device, such that the operation of the separation apparatus and/or transfer apparatus and/or relocation apparatus and/or wrapping apparatus can be controlled via the central drive element.

Conveying apparatuses, which are e.g. formed by or comprise conveyor belts, for conveying filter body material and/or blanks, and/or deflection apparatuses, which are e.g. formed by or comprise deflection rollers or drums, for deflecting the filter body material from a first movement path onto a second movement path, and/or relocation apparatuses, which are e.g. formed by or comprise relocation elements mounted so as to be movable in at least one degree of freedom, such as grippers, suction units, etc., for relocating blanks from a first orientation and/or position into a second orientation and/or position, may be arranged or formed between the above-mentioned parts of the device.

A specific embodiment of a corresponding relocation apparatus may comprise one or more relocation modules, which are mounted so as to be movable on at least one movement path into a first orientation and/or position, which can also be referred to as a receiving orientation and/or position, in which it is possible to receive at least one corresponding blank from the separation apparatus and/or a conveying apparatus arranged downstream therefrom, and into a second orientation and/or position, which can also be referred to as a passing orientation and/or position, in which it is possible to pass a corresponding blank to the wrapping apparatus, i.e. in particular to a corresponding conical wrapping body. A blank held by means of a corresponding relocation module can therefore be passed to a corresponding conical wrapping body of the wrapping apparatus in the passing orientation and/or position. In particular, a blank held by means of the relocation apparatus can be passed into a corresponding receiving contour of a conical wrapping body in the passing orientation and/or position.

The respective drives of the conical wrapping body and the relocation apparatus can therefore be coordinated with one another, e.g. by synchronisation, such that a corresponding receiving contour and a blank held by means of the relocation apparatus are arranged or oriented in the passing orientation and/or position so as to be adjacent to one another or aligned with one another such that the blank can be passed into the receiving contour. This can in particular be understood to be a portion of a corresponding blank engaging in a corresponding receiving contour. For this purpose, e.g. in order to utilise gravitational forces for stabilising the respective blanks, a suspended or vertical orientation of the respective blanks may be expedient; a blank held by means of the relocation apparatus may therefore be oriented so as to be suspended or vertical in the passing orientation and/or position.

A movement of a corresponding relocation module may e.g. be a pivoting movement about a pivot axis, i.e. about a (substantially) horizontal pivot axis, for example, such that the first orientation and/or position is correlated with a first pivot position of the relocation module and the second orientation and/or position is correlated with a second pivot position of the relocation module. In the second pivot position, the relocation module may e.g. be pivoted by an angle in a range between 45° and 135°, in particular 90°, relative to the first orientation and/or position.

In principle, however, other movements of a corresponding relocation module, e.g. in translational degrees of freedom or in combined translational and/or rotational degrees of freedom, are conceivable.

It should also be mentioned in this connection that respective movement paths for moving a corresponding relocation module from the first orientation and/or position into the second orientation and/or position may be identical to or different from movements of the relocation module from the second orientation and/or position into the first orientation and/or position.

It should also be mentioned that a corresponding conical wrapping body can be mounted so as to be movable in a translational degree of freedom, e.g. in parallel with its axis of symmetry, in addition to being rotatably mounted, as described. This may be expedient for moving the conical wrapping body into a position in which it is possible to pass along a blank held by means of the relocation apparatus in the passing orientation and/or position.

A translational movement of a corresponding conical wrapping body may, however, also be expedient for moving, therefore pulling, the conical wrapping body out of a fully wrapped conical filter body after a wrapping process, which typically includes between 4 and 10 revolutions or wraps of the blank, in order for it to be possible to remove the fully wrapped filter body from the wrapping apparatus.

It is clear from the above information that, according to the method, a wrapping apparatus can be used as a connecting apparatus which comprises at least one conical wrapping body which is mounted so as to be movable in at least two different degrees of freedom. In particular, a wrapping apparatus can be used as a connecting apparatus which comprises at least one conical wrapping body which is mounted so as to be movable in a rotational degree of freedom about the axis of symmetry of the wrapping body and in a translational degree of freedom along the axis of symmetry of the wrapping body or an axis parallel thereto.

In order to remove a fully wrapped filter body from the wrapping apparatus, auxiliary apparatuses, such as scraper apparatuses, may also be provided, which assist in the removal of a fully wrapped conical filter body from a wrapping body.

In all the embodiments, a corresponding relocation module may comprise one or more relocation elements, which each have a bar-like or bar-shaped geometry. Corresponding bar-like or bar-shaped relocation elements may be arranged to be adjacent in order to form an, in particular rake-like or rake-shaped, rest or support structure for at least one corresponding blank.

Corresponding bar-like or bar-shaped relocation elements may be arranged on a base structure of the relocation module. In this case, a configuration is in particular possible according to which one or more first bar-like or bar-shaped relocation elements are arranged in a first spatial plane on a base structure and one or more second bar-like or bar-shaped relocation elements are arranged in a second spatial plane on the base structure, such that the rest or support structures formed by the respective bar-like or bar-shaped relocation elements are likewise arranged in different spatial planes.

Corresponding bar-like or bar-shaped relocation elements may each comprise one or more flow ducts, which communicate with a flow-generating apparatus generating a suction flow and open into flow openings, via which it is possible to pneumatically hold a corresponding blank at least temporarily, in particular during a movement of the relocation module from a first orientation and/or position into a second orientation and/or position. In order to detach the blank from the corresponding bar-like or bar-shaped relocation elements of the relocation module in connection with passing a corresponding blank from the relocation module to a corresponding conical wrapping body, the or an additional flow-generating apparatus can be configured to generate a blowing flow, at least briefly and as required. The blowing flow can be implemented by a jet of compressed air, for example.

The above-described configuration of the apparatuses of the device, i.e. in particular the transfer apparatus and the relocation apparatus, allows for industrially applicable, high-precision relocation of corresponding blanks and, as a result, high-precision wrapping of corresponding blanks in order to produce conical filter bodies, and this results in technically and also economically highly efficient production of conical filter bodies.

Corresponding conveying apparatuses may be provided with positioning apparatuses, which ensure that corresponding blanks are securely positioned during conveying. Corresponding positioning apparatuses may be configured to bring about mechanical positioning of corresponding blanks, e.g. by applying positioning forces. Alternatively or additionally, corresponding positioning apparatuses may be configured to bring about pneumatic positioning of corresponding blanks.

In the same way, positioning apparatuses may be configured to bring about positioning of the filter body material and/or corresponding blanks during separation or connection. In this way, the above-mentioned sheet-edge control can be implemented, for example.

The device may further comprise safety apparatuses, formed by covers, for example, which prevent undesired access to the parts of the device.

The device may further comprise a control apparatus implemented with hardware and/or software for controlling the operation of the device, i.e. in particular also for controlling the operation of the parts of the device. The control apparatus may communicate with individual controllers (if provided) of the respective parts of the device, e.g. for transmitting control information.

An output apparatus, such as a display apparatus, may be assigned to the control apparatus, by means of which output apparatus information relating to the operation of the device or of individual parts of the device can be output or displayed.

A corresponding display apparatus, e.g. in the form of a touch display, may be a part of an operating or monitoring apparatus of the device forming a user interface, by means of which apparatus the device can be operated and/or monitored. A corresponding operating or monitoring apparatus may be mounted so as to be movable in at least one degree of freedom by a holding apparatus, which is e.g. implemented by a movably mounted supporting arm.

The device may further comprise a detection apparatus for detecting fully wrapped conical filter bodies. A corresponding detection apparatus may e.g. be configured for counting fully wrapped conical filter bodies and/or for detecting certain geometric parameters of fully wrapped conical filter bodies. A corresponding detection apparatus may e.g. comprise one or more optical detection elements, i.e. in the form of cameras, barriers, etc. Detection information provided by the detection apparatus can be transmitted to the control apparatus, in particular in real time, and, for example for the purpose of monitoring quality, can be taken as a basis for the control of the operation of individual, multiple or all of the apparatuses of the device.

Individual, multiple or all of the above-mentioned parts or apparatuses of the device may be arranged or formed on an, e.g. frame-like or frame-shaped, frame structure (machine frame).

Individual, multiple or all of the above-mentioned parts or apparatuses of the device may e.g. be designed to be modular, such that they can be replaced simply and rapidly, e.g. in the event of servicing and/or repairs.

A fourth aspect of the invention relates to a method for producing a filter for a smokable product, such as a cannabis cigarette, which is commonly referred to as a “joint”. The method comprises the steps of:
providing at least one conical filter body which has been produced according to the method according to the first aspect,
filling the at least one filter body with a filter material, in particular an activated carbon material,
closing the at least one filter body, in particular by means of closure pieces, which are connected at the ends to the filled filter body, e.g. in a form-fitting, force-locked and/or material-bonded manner, and are e.g. made of ceramic or plastics material, to form the filter.

All the embodiments relating to the method according to the first aspect apply, at least as regards the filter body, by analogy to the method according to the fourth aspect, and vice versa.

The method according to the first aspect can be combined with the method according to the fourth aspect. In this way, an efficient method for producing filters is provided which includes both the production of a filter body and also, starting therefrom, the production of a filter.

A fifth aspect of the invention relates to a filter, which is characterised in that it has been produced according to the method according to the fourth aspect. All the embodiments relating to the method according to the fourth aspect apply by analogy to the filter according to the fifth aspect.

The invention is explained again on the basis of embodiments in the drawings, in which:

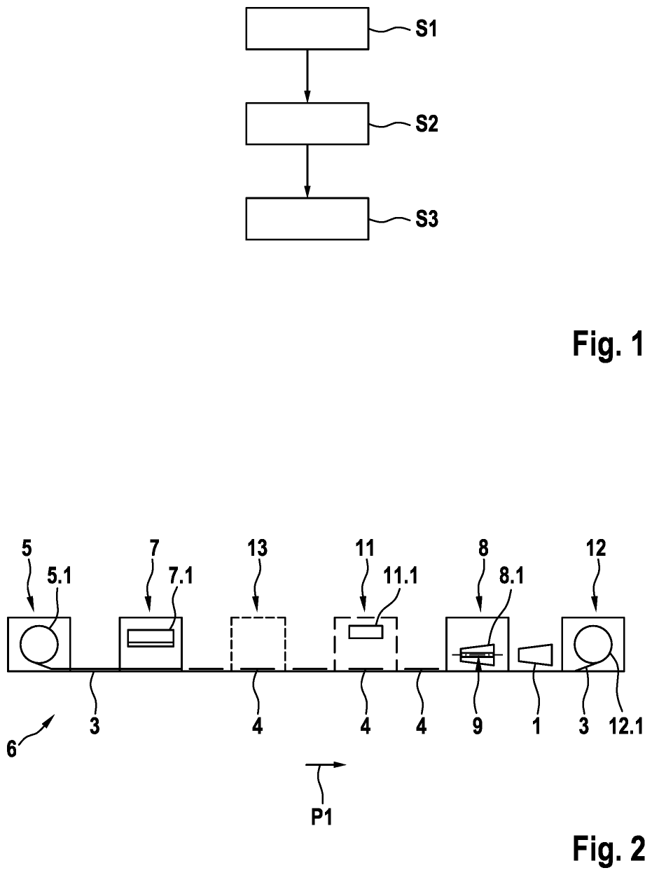

FIG. 1 is a flow diagram illustrating a method for producing a filter body according to an embodiment;

FIG. 2 is a purely schematic view of a device for carrying out a method according to an embodiment;

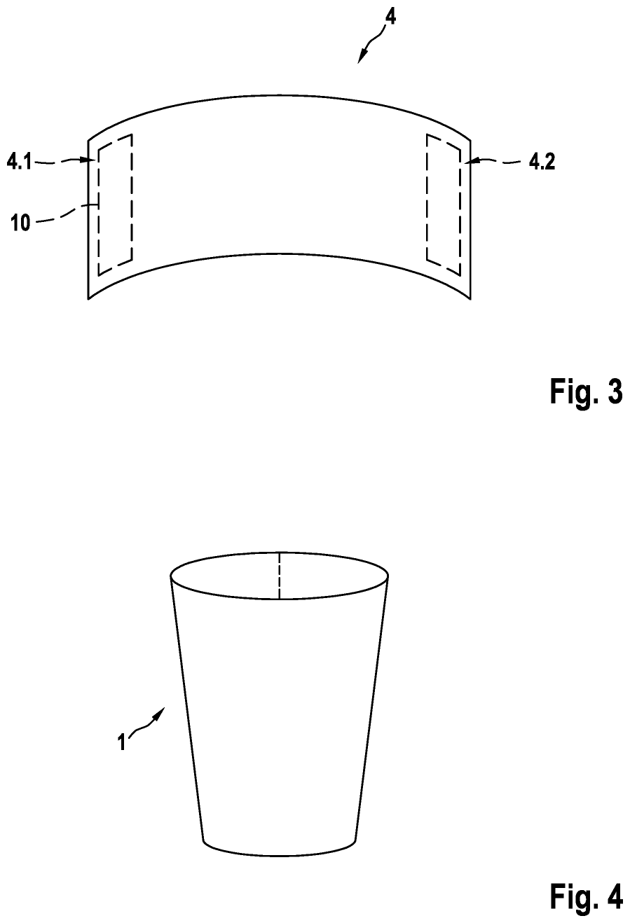

FIG. 3 is a schematic plan view of a blank according to an embodiment;

FIG. 4 is a schematic perspective view of a filter body according to an embodiment;

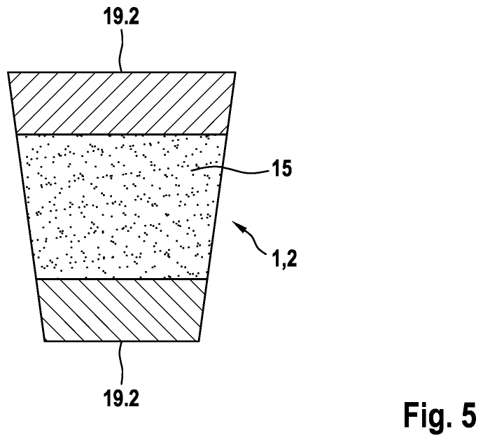

FIG. 5 is a schematic sectional view of a filter according to an embodiment;

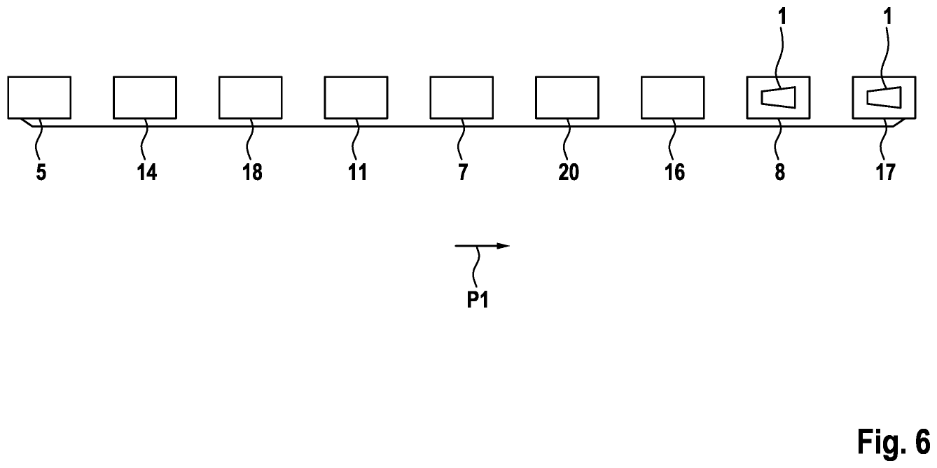

FIG. 6 is a purely schematic view of a device for carrying out a method according to another embodiment;

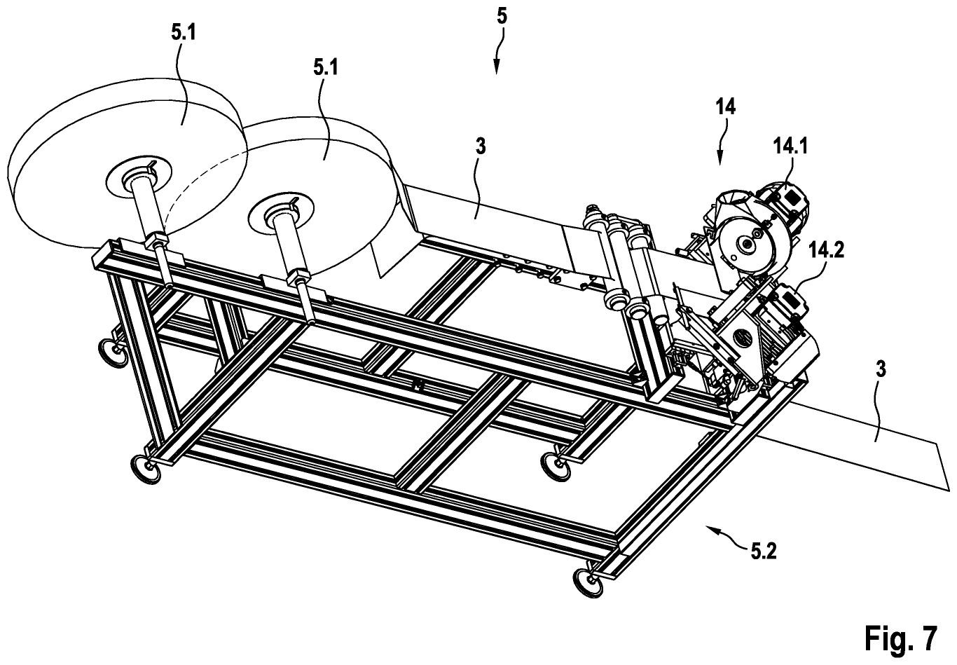

FIG. 7 is a schematic view of a provision apparatus in addition to a mechanical processing apparatus according to an embodiment;

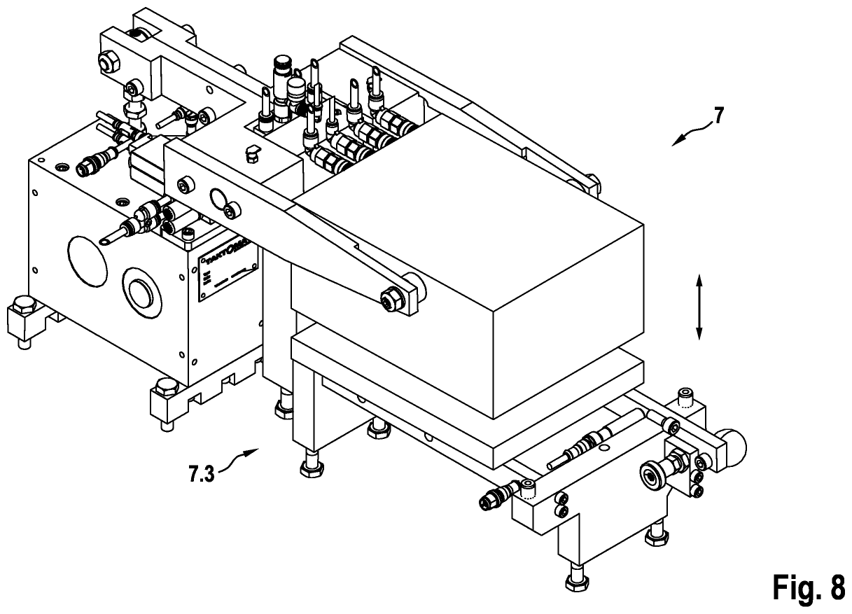

FIG. 8 is a schematic view of a separation apparatus according to an embodiment;

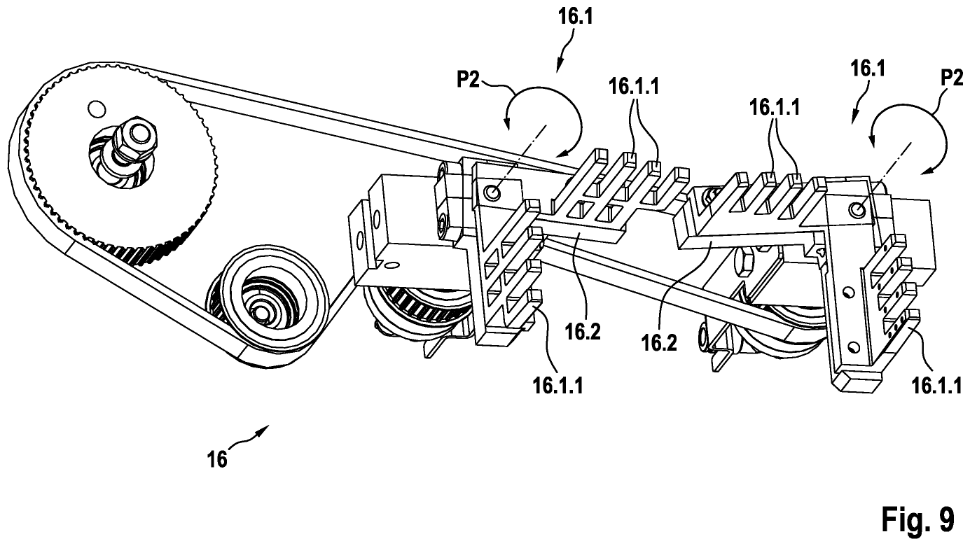

FIG. 9 is a schematic view of a relocation apparatus according to an embodiment;

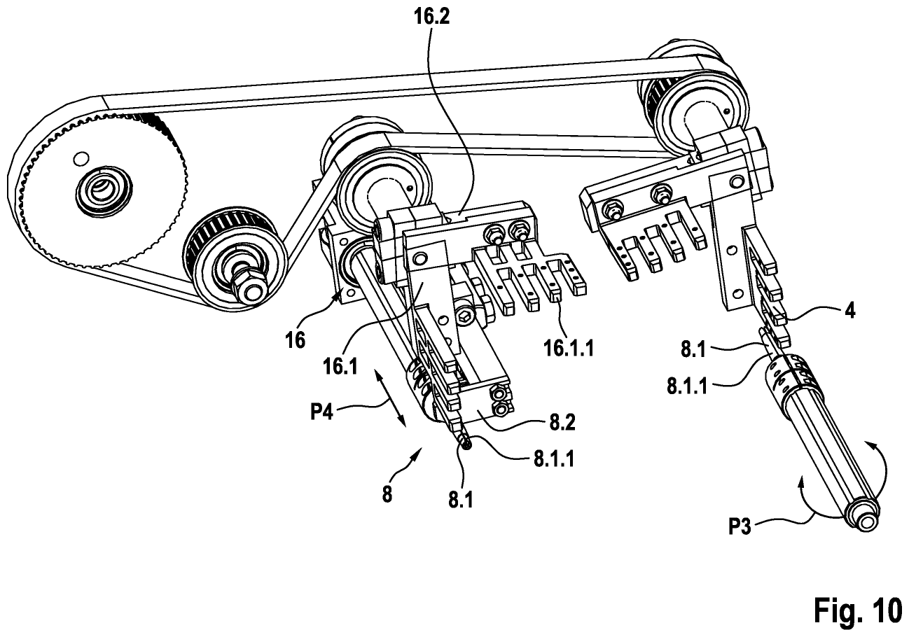

FIG. 10 is a schematic view of a relocation apparatus and a connecting apparatus according to an embodiment; and

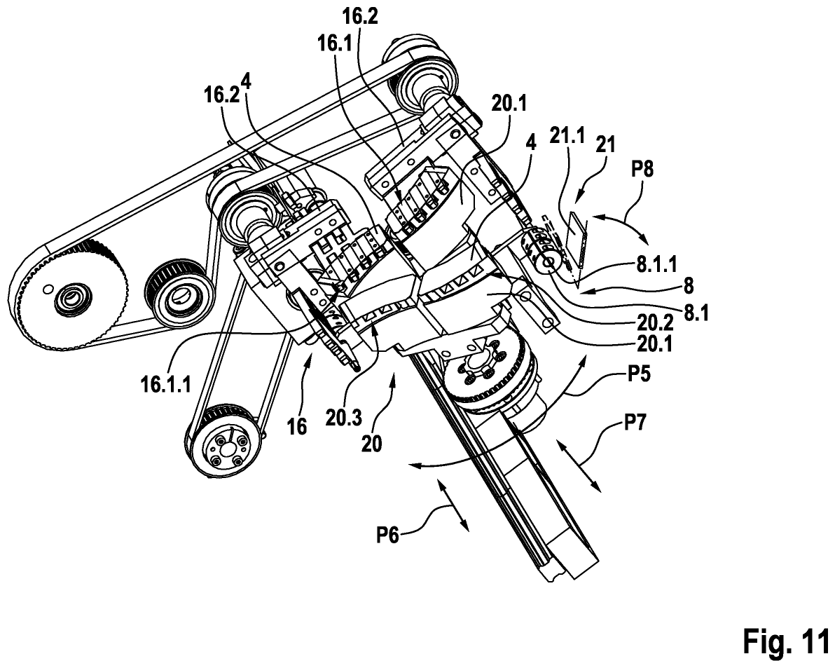

FIG. 11 is a schematic view of a transfer apparatus, a relocation apparatus and a connecting apparatus according to an embodiment.

FIG. 1 is a flow diagram illustrating a method according to an embodiment.

The method is used for producing a conical filter body 1 (cf. FIG. 4) for a conical filter 2 (cf. FIG. 5) of a smokable product, such as a cannabis cigarette, which is commonly also referred to as a “joint”, or other tobacco products that can be consumed in the same or a similar way. A conical filter body 1 that is or can be produced according to the method has a sleeve-like or sleeve-shaped three-dimensional conical basic shape, such that a filter body 1 that is or can be produced according to the method can also be referred to or considered as a filter sleeve.

According to the method, filter bodies 1 may e.g. be produced that have a length or height of max. 50 mm, in particular max. 40 mm, more particularly max. 30 mm, a minimum internal diameter of 5 mm, a maximum internal diameter of 10 mm, and a maximum cone angle in a range between 2 and 5°, in particular of 3°. Of course, filter bodies 1 having other geometric parameters can also be produced in principle.

The method shown in the embodiment according to FIG. 1 comprises the following steps, which are described in greater detail in the following:

In a first step S1 of the method, a strip-like or strip-shaped filter body material 3 is provided. In the first step S1 of the method, a strip-like or strip-shaped filter body material 3 is therefore provided. The filter body material 3 may be provided continuously, semi-continuously or discontinuously.

For example, the filter body material 3 may be a paper, in particular a filter paper. The paper may have a certain absorbency. It is conceivable for a filter body material 3 to be used which is provided with perforations, i.e. in general with weakened points, in order to facilitate particularly simple and exact separation and therefore the formation of blanks 4, which are described in greater detail below.

The filter body material 3 can be provided by means of a provision apparatus 5, which can form a part of a device 6 (cf. FIG. 2) used for carrying out the method. The provision apparatus 5 may be designed as a rolling, spooling or wrapping body 5.1 or may comprise at least one such body, such that the filter body material 3 can be unrolled, unspooled or unwrapped from a corresponding rolling, spooling or wrapping body 5.1, in particular at a statically or dynamically variable speed. The filter body material 3 may accordingly be provided as continuous material that is rolled, spooled or wrapped onto a corresponding rolling, spooling or wrapping body 5.1. In general, the filter body material 3 may be provided in an automated manner.

In a second step S2 of the method, at least one blank 4 having a predefined geometry is separated from the provided filter body material 3. In the second step S2 of the method, at least one blank 4 having a predefined geometry is therefore separated from the provided filter body material 3. The separation of corresponding blanks 4, which can be carried out in one or more separation steps, can be carried out continuously, semi-continuously or discontinuously. A predefined geometry of a blank 4 prefabricated by a corresponding separation process is generally understood to be a geometry from which a three-dimensional cone or truncated cone can be formed, e.g. by rolling, spooling or wrapping. In particular, strip-like or strip-shaped geometries come into consideration (cf. FIG. 3), since a three-dimensional cone can be formed therefrom comparatively easily.

The corresponding blanks 4 can be separated by means of a separation apparatus 7, which can form a part of a device 6 used for carrying out the method. The separation apparatus 7 may e.g. be designed as a mechanical separation apparatus, i.e. a cutting or stamping apparatus, for example, or an optical separation apparatus, i.e. a laser-cutting apparatus, for example, or may comprise at least one such apparatus. The separation apparatus 7 may therefore comprise at least one mechanical and/or optical cutting element 7.1, such as a stamping blade or a cutting laser. The corresponding blanks 4 can therefore be separated from the filter body material 3 e.g. by means of a mechanical separation process, in particular a cutting or stamping process, and/or by means of an optical separation process, in particular a laser-cutting process. The speed of the separation process is typically adapted to the speed of the provision process. In general, the corresponding blanks 4 may be separated in an automated manner.

In the second step S2, a plurality of blanks 4 are typically separated from the filter body material 3 simultaneously or in succession, such that there are typically a plurality of blanks 4 after the second step S2.

In a third step S3 of the method, at least two portions 4.1, 4.2 of a relevant blank 4 (cf. FIG. 3) are connected to form a conical filter body 1 (cf. FIG. 4). In the third step S3 of the method, at least two portions 4.1, 4.2 of a relevant blank 4 are therefore interconnected to form a three-dimensional conical filter body 1. The respective portions 4.1, 4.2 of corresponding blanks 4 can be connected continuously, semi-continuously or discontinuously. During the connection of the at least two portions 4.1, 4.2, a relevant blank 4 is brought from its original spatial form, i.e. typically a (substantially) two-dimensional spatial form (cf. FIG. 3), into a three-dimensional conical spatial form (cf. FIG. 4). It can be seen from FIG. 3 that corresponding portions 4.1, 4.2 of a relevant blank 4 may be free ends of the blank 4 that are opposite one another, or corresponding portions 4.1, 4.2 may be arranged in the region of opposite free ends, i.e. short opposite ends in particular, of the relevant blank 4. As is clear from the following, the connection of respective portions 4.1, 4.2 of a relevant blank 4 may also include form-fitting and/or force-locked and/or material-bonded fixing of the blank 4 brought into a corresponding three-dimensional conical spatial form and therefore fixing of the cone geometry of the formed filter body 1 in question.

The at least two portions 4.1, 4.2 of a relevant blank 4 can be connected by means of a connecting apparatus 8, which can form a part of the device 6 used for carrying out the method. The connecting apparatus 8 may be formed as a wrapping apparatus or may comprise at least one such apparatus. The filter body 1 may therefore be formed by wrapping at least one relevant blank 4 once or multiple times onto a wrapping body 8.1, wherein the at least two portions 4.1, 4.2 of the relevant blank are likewise interconnected. The speed of the connection of the at least two portions 4.1, 4.2 of a relevant blank 4 to form a conical filter body 1 may be adapted to the speed of the provision process and/or to the speed of the separation process. In general, the at least two portions 4.1, 4.2 of a relevant blank 4 may be connected to form a conical filter body 1 in an automated manner.

Typically, a wrapping body 8.1 is used which has an axis of symmetry or a central axis about which it can be rotatably mounted. A conical wrapping body 8.1 is preferably used which reproduces the geometry of the filter body 1 to be produced. A relevant blank 4 can therefore be wrapped around a conical wrapping body 8.1 once or multiple times, and therefore wrapped onto a corresponding wrapping body 8.1, as a result of which the blank 4 is brought into the three-dimensional conical spatial form.

According to the method, a wrapping body 8.1 comprising a fixing apparatus 9, which optionally also forms a part of a device used to carry out the method, can be used as part of a wrapping process for, in particular mechanically and/or pneumatically, temporarily fixing a relevant blank 4. Therefore, a corresponding blank 4 can be temporarily fastened during a wrapping process, and this makes it easier to bring the blank 4 into the three-dimensional conical spatial form. The fixing apparatus 9 may be configured for fastening a corresponding blank 4 at one or more points, or optionally even over its (full) surface. Mechanical fixing of a blank 4 may e.g. be implemented by one or more, e.g. slot-like or slot-shaped, cut-outs in a corresponding wrapping body 8.1, by means of which a blank 4 can be temporarily fixed, in particular by a short side, e.g. by being inserted. Pneumatic fixing of a blank 4 may e.g. be implemented by one or more vacuum openings in a corresponding wrapping body 8.1, by means of which a blank 4 can be temporarily fastened, in particular by a short side, e.g. by suction. Temporary fixing may also include temporary fixing of the blank 4 in an orientation that is desired for bringing said blank into the three-dimensional conical spatial form.

In the third step S3, a plurality of conical filter bodies 1 may be formed simultaneously or in succession, such that there may be a plurality of filter bodies 1 after the third step.

The method therefore provides a principle for producing conical filter bodies 1 that can be presented as being extremely efficient because it can be (fully) automated, which principle takes a provided filter body material 3 as a starting point, from which one or more blanks 4 are separated, by means of corresponding separation processes, such as cutting or stamping processes, from which blanks conical filter bodies 1 are then formed. As mentioned, the steps S1-S3 of the method can be carried out continuously, semi-continuously or discontinuously, such that a customised degree of automation and productivity can be implemented.

As shown in FIG. 3, in the second step S2, blanks 4 having strip-like or strip-shaped geometries, i.e. generally having elongate geometries, can in particular be separated from the filter body material 3, since three-dimensional cones can be formed from these geometries comparatively easily. Blanks 4, as shown in FIG. 3, having curve-like or curved basic shapes, i.e. generally blanks 4 having parabola-like or parabolic basic shapes, are particularly preferred here. A curve-like or curved basic shape does not necessarily have to be limited to a simple curve; multiple curves are also conceivable, which can result in an undulating basic shape of a corresponding blank 4.

As mentioned, the connection of respective portions 4.1, 4.2 of a corresponding blank 4 may also include material-bonded fixing of the blank 4 brought into a corresponding three-dimensional conical spatial form and therefore fixing of the cone geometry of the formed filter body 1 in question. Before connecting the at least two portions 4.1, 4.2 of a corresponding blank 4, i.e. in particular before a corresponding blank 4 is rolled or wrapped onto a wrapping body 8.1, an adhesive material 10, such as an adhesive, glue, etc., can therefore be applied to the blank 4. The adhesive material 10 applied in individual dots and/or lines e.g. to, or in the region of, at least one short side of a blank 4 may require material-bonded fixing of the blank 4 brought into a corresponding three-dimensional conical spatial form and therefore fixing of the cone geometry of the formed filter body 1 in question.

A corresponding adhesive material 10 can be applied by means of an application apparatus 11 used as a part of the device 6 used for carrying out the method. The device 6 may therefore comprise an application apparatus 11 for applying an adhesive material 10 to a relevant blank 4 before connecting the at least two portions 4.1, 4.2 of a blank 4. The application apparatus 11 may comprise at least one, e.g. nozzle-like or nozzle-shaped, application element 11.1. The at least one application element 11.1 may be mounted so as to be movable in at least one degree of freedom.

After separating corresponding blanks 4, the filter body material may be collected in a collection apparatus 12, with the filter body material 3 then typically having a structure provided with cut-outs arranged in a grid-like or grid-shaped manner. The collection apparatus 12, which optionally likewise forms a part of the device 6 used for carrying out the method, may e.g. be designed as a rolling, spooling or wrapping body or may comprise at least one such body, such that, after separating corresponding blanks 4, the filter body material 3 can be collected on a corresponding wrapping body 12.1, e.g. by being rolled, spooled or wrapped, and can then either be disposed of or fed to a third or subsequent process.

The embodiment in FIG. 2 shows an, e.g. (revolver) magazine-like or (revolver) magazine-shaped, collection apparatus 13 forming an optional part of the device 6 used for carrying out the method, by means of which collection apparatus corresponding blanks 4 can be temporarily collected before the blanks 4 are brought into their three-dimensional conical spatial form. Previously temporarily collecting the blanks 4 may e.g. be advantageous because the blanks 4 can again be brought into an orientation and/or position that is expedient for the connection and can optionally be stabilised before their respective portions 4.1, 4.2 are connected.

Before separating corresponding blanks 4 from the filter body material 3, the filter body material 3 can (optionally) be marked, in particular printed. Alternatively or additionally, after separating corresponding blanks 4 from the filter body material 3, the blanks 4 can be marked, i.e. in particular printed. Said filter body material or blanks can be marked or printed by means of a marking or printing apparatus (not shown), which can optionally likewise form a part of the device 6 used for carrying out the method. A corresponding marking or printing apparatus may e.g. be formed as an embossing or inkjet-printer apparatus or may comprise at least one such apparatus. It is likewise conceivable to use an already marked, i.e. in particular printed, filter body material 3 as the starting material.

The material flow within the device 6 is shown in FIG. 2 by the arrow P1.

In connection with the embodiment, shown in FIG. 2, of a corresponding device 6 for producing conical filter bodies 1, the following also applies:

Conveying apparatuses (not provided with a reference sign), which are e.g. formed by or comprise conveyor belts, for conveying filter body material 3 and/or blanks 4, and/or deflection apparatuses (not shown), which are e.g. formed by or comprise deflection rollers or drums, for deflecting the filter body material 3 from a first movement path onto a second movement path, and/or relocation apparatuses (not shown), which are e.g. formed by or comprise relocation elements mounted so as to be movable in at least one degree of freedom, such as grippers, suction units, etc., for relocating blanks 4 from a first orientation and/or position into a second orientation and/or position, may optionally be arranged or formed between the above-mentioned parts of the device 6.

Corresponding conveying apparatuses may be provided with positioning apparatuses, which ensure that corresponding blanks are securely positioned during conveying. Corresponding positioning apparatuses may be configured to bring about mechanical positioning of corresponding blanks, e.g. by applying positioning forces. Alternatively or additionally, corresponding positioning apparatuses may be configured to bring about pneumatic positioning of corresponding blanks.

In the same way, positioning apparatuses may be configured to bring about positioning of the filter body material and/or corresponding blanks during separation or connection.

The device 6 may further comprise safety apparatuses (not shown), formed by covers, for example, which prevent undesired access to the parts of the device 6.

The device 6 may further comprise a control apparatus (not shown) implemented with hardware and/or software for controlling the operation of the device 6, i.e. in particular also for controlling the operation of the parts of the device 6. The control apparatus may communicate with individual controllers (if provided) of the respective parts of the device 6, e.g. for transmitting control information.

An output apparatus (not shown), such as a display apparatus, may be assigned to the control apparatus, by means of which output apparatus information relating to the operation of the device 6 or of individual parts of the device 6 can be output or displayed.

Individual, multiple or all of the above-mentioned parts of the device 6 may be arranged or formed on an, e.g. frame-like or frame-shaped, frame structure (not shown).

Individual, multiple or all of the above-mentioned parts of the device 6 may e.g. be designed to be modular, such that they can be replaced simply and rapidly, e.g. in the event of servicing and/or repairs.

FIG. 6 is a purely schematic view of a device 6 for carrying out a method according to another embodiment.

The device 6 according to the embodiment shown in FIG. 6 comprises the following apparatuses: a provision apparatus 5 for providing a strip-like or strip-shaped filter body material, a mechanical processing apparatus 14 for mechanically processing at least portions of the filter body material 3 provided by the provision apparatus 5, a marking or printing apparatus 18 for marking, in particular printing, the filter body material 3, a material-application apparatus 11 for applying an adhesive material to the filter body material 3, a separation apparatus 7 for separating blanks 4 from the filter body material 3, a transfer apparatus 20 for passing blanks 4 to a relocation apparatus 16, a corresponding relocation apparatus 16 for relocating blanks 4 to a connecting apparatus 8, a corresponding connecting apparatus 8 for connecting respective portions 4.1, 4.2 of a blank 4 for forming a conical filter body 1 and a collection apparatus 17 for collecting fully produced conical filter bodies 1.

As shown, the above-mentioned apparatuses of the device 6 are arranged to be connected in succession in the direction of the material flow, which is shown again by the arrow P1.

FIG. 7 is a schematic perspective view of the provision apparatus 5 together with the mechanical processing apparatus 14 according to an embodiment. This may be a specific embodiment of the provision apparatus 5 and the mechanical processing apparatus 14 shown in FIG. 6.

It can be seen from FIG. 7 that the provision apparatus 5 may comprise a plurality of rolling, spooling or wrapping bodies 5.1, by means of which a strip-like or strip-shaped filter body material 3 can be provided in each case. In this way, it is possible to provide a filter body material 3 either via a first or a second rolling, spooling or wrapping body 5.1. Interruptions to the operation of the device 6 caused by changing or replacing a rolling, spooling or wrapping body 5.1 can therefore be considerably reduced. The provision apparatus 5 may comprise an, e.g. frame-like or frame-shaped, mounting apparatus 5.2, by means of which a plurality of rolling, spooling or wrapping bodies 5.1 can be mounted beside one another or successively, as shown by way of example in the drawings.

The mechanical processing apparatus 14, which is likewise shown in FIG. 7 and is arranged downstream of the provision apparatus 5, in principle is configured for mechanically processing at least portions of the filter body material 3 unwrapped from a rolling, spooling or wrapping body 5.1. The mechanical processing is carried out with the aim of preparing the filter body material 3 for subsequent process steps, such as material-application steps, connection steps, etc. Specifically, in the embodiment, the mechanical processing apparatus 14 comprises a plurality of grinding apparatuses 14.1, which are configured for grinding and thus roughening the filter body material 3 fed thereto in edge regions that are at the sides in the conveying or feed direction; corresponding side edge regions may take up e.g. 0.1-1.5 mm, based on the dimensions of the filter body material 3 in the transverse extension. In order for it to be possible to accordingly mechanically process both side edge regions of the filter body material 3, a first grinding apparatus 14.1 is provided for mechanically processing a first edge region of the filter body material 3 and a second grinding apparatus 14.2 is provided for mechanically processing a second edge region of the filter body material 3.

As shown, the grinding apparatuses 14.1, 14.2 may likewise be arranged on the mounting apparatus 5.2 of the provision apparatus 5.

FIG. 8 shows a schematic diagram of a separation apparatus 7 according to an embodiment. This may be a specific embodiment of the separation apparatus 7 shown in FIG. 6.

The separation apparatus 7 is designed as a mechanical separation apparatus, i.e. a cutting or stamping apparatus and comprises one or more cutting or stamping elements 7.1, such as cutting or stamping punches (not shown). The cutting or stamping apparatus mounted via a frame 7.3 configured by way of example may comprise a purely schematically shown punch/die pair, wherein the punch is movable relative to the die, or vice versa, to produce stroke movements in a degree of freedom shown by the double-headed arrow, which is not provided with a reference sign in FIG. 8.

The cutting or stamping elements may be ground at an angle in a range between 1 and 10°, in particular between 3 and 7°. In this way, a silhouette can be produced, which can reduce the separation forces required.

The separation apparatus 7 may comprise a plurality of separate separation elements 7.1 for carrying out different separation processes, i.e. a pre-separation step and a main separation step, for example. For the implementation as a cutting or stamping apparatus, the separation apparatus 7 can therefore comprise one or more cutting or stamping elements 7.1 for carrying out different cutting or stamping processes, i.e. in particular a pre-cutting step or pre-stamping step, and one or more cutting or stamping elements for carrying out a main cutting step or main stamping step.

The separation apparatus 7 may in particular be configured for separating a plurality of blanks 4, i.e. in particular left and right blanks 4, from the filter body material 3 fed thereto in one stroke, which blanks can, furthermore, be fed to separate wrapping apparatuses as part of the connecting apparatus 8.

FIG. 9 is a schematic view of a relocation apparatus 16 according to an embodiment in a perspective view of the essential elements. This may be a specific embodiment of the relocation apparatus 16 shown in FIG. 6.

FIG. 10 is a schematic view of a relocation apparatus 16 and a connecting apparatus 8 according to an embodiment in a perspective view of the essential elements. This may be a specific embodiment of the relocation apparatus 16 and connecting apparatus 8 shown in FIG. 6.

It is clear from FIGS. 9 and 10 that a relocation apparatus 16 may comprise a plurality of relocation modules 16.1, which are mounted so as to be movable on at least one movement path into a first orientation and/or position, which can also be referred to as a receiving orientation and/or position, in which it is possible to receive at least one corresponding blank 4 from the separation apparatus 7 and/or a conveying apparatus arranged downstream therefrom, and into a second orientation and/or position, which can also be referred to as a passing orientation and/or position, in which it is possible to pass a corresponding blank 4 to a connecting apparatus 8 designed as a wrapping apparatus, i.e. in particular to a corresponding conical wrapping body 8.1. As shown in FIG. 10, a blank 4 held by means of a corresponding relocation module 16.1 can therefore be passed to a corresponding conical wrapping body 8.1 of the wrapping apparatus in the passing orientation and/or position. In particular, a blank 4 held by means of a relocation apparatus 16 can be passed into a corresponding receiving contour 8.1.1 of a conical wrapping body 8.1 in the passing orientation and/or position.

A corresponding receiving contour 8.1.1 may e.g. be formed by a groove, a slot or another cut-out in the wrapping body 8.1 and may be used for receiving portions of a blank 4, i.e. in particular a short end of a blank 4. A corresponding receiving contour 8.1.1 may be oriented so as to extend coaxially with the axis of symmetry of the conical wrapping body 8.1 and may optionally constitute a part of a fixing apparatus for mechanically and/or pneumatically temporarily fixing a relevant blank 4 as part of a wrapping process.

The respective drives of the conical wrapping bodies 8.1 of the wrapping apparatus and the relocation apparatus 16 can therefore be coordinated with one another, e.g. by synchronisation, such that a corresponding receiving contour 8.1.1 and a blank 4 held by means of the relocation apparatus 16 are arranged or oriented in the passing orientation and/or position so as to be adjacent to one another or aligned with one another such that the blank 4 can be passed into the receiving contour 8.1.1. This can in particular be understood to be a portion of a corresponding blank 4 engaging in a corresponding receiving contour 8.1.1. As shown in FIG. 10, for this purpose, e.g. in order to utilise gravitational forces for stabilising the blanks 4, a suspended or vertical orientation of the blanks 4 may be expedient; a blank 4 held by means of the relocation apparatus 16 may therefore be oriented so as to be suspended or vertical in the passing orientation and/or position.

As shown by the double-headed arrow P2, a movement of a corresponding relocation module 16.1 may be a pivoting movement about a horizontal pivot axis (not provided with a reference sign), such that the first orientation and/or position is correlated with a first pivot position of a relevant relocation module 16.1 and the second orientation and/or position is correlated with a second pivot position of the relevant relocation module 16.1. In the second pivot position, a relevant relocation module 16.1 may be pivoted by an angle in a range between 45° and 135°, in particular 90°, relative to the first orientation and/or position.

It should also be mentioned that, in addition to being rotatably mounted, as shown by the arrows P3, respective conical wrapping bodies 8.1 of the wrapping apparatus can be mounted so as to be movable about their axes of symmetry, as shown by the arrows P4, in a translational degree of freedom, e.g. in parallel with their axes of symmetry. This may be expedient for moving the respective conical wrapping bodies 1 into a position in which it is possible to pass along a blank 4 held by means of the relocation apparatus 16 in the passing orientation and/or position.

A translational movement of the conical wrapping bodies 8.1 may, however, also be expedient for moving, therefore pulling, the conical wrapping bodies 8.1 out of a fully wrapped conical filter body 1 after a wrapping process, which typically includes between 4 and 10 revolutions or wraps of the blanks 4, in order for it to be possible to remove the fully wrapped filter body 1 from the wrapping apparatus.

In order to remove fully wrapped filter bodies 1 from the wrapping apparatus, auxiliary apparatuses, such as scraper apparatuses 8.2, may also be provided, which assist in the removal of the fully wrapped conical filter bodies 1 from a relevant wrapping body 8.1.

It can be seen from FIGS. 9 and 10 that a corresponding relocation module 16.1 may comprise a plurality of relocation elements 16.1.1, which each have a bar-like or bar-shaped geometry. Corresponding bar-like or bar-shaped relocation elements 16.1.1 may be arranged to be adjacent in order to form a rest or support structure for a corresponding blank 4.

The bar-like or bar-shaped relocation elements 16.1.1 may be arranged on a base structure 16.2 of the relocation module 16. In this case, as shown in FIGS. 9 and 10, a configuration is possible according to which first bar-like or bar-shaped relocation elements 16.1.1 are arranged in a first spatial plane on the base structure 16.2 and second bar-like or bar-shaped relocation elements 16.1.1 are arranged in a second spatial plane on the base structure 16.2, such that the rest or support structures formed by the respective bar-like or bar-shaped relocation elements 16.1.1 are likewise arranged in different spatial planes.

The bar-like or bar-shaped relocation elements 16.1.1 may each comprise one or more flow ducts (not shown), which communicate with a flow-generating apparatus generating a suction flow and open into flow openings (not shown), via which it is possible to pneumatically hold a corresponding blank 4 at least temporarily, in particular during a movement of the relocation module 16.1 from a first orientation and/or position into a second orientation and/or position. In order to detach the blank 4 from the corresponding bar-like or bar-shaped relocation elements 16.1.1 of the relocation module 16.1 in connection with passing a corresponding blank 4 from the relocation module 16.1 to a corresponding conical wrapping body 8.1, the or an additional flow-generating apparatus can be configured to generate a blowing flow, at least briefly and as required. The blowing flow can be implemented by a jet of compressed air, for example.

FIGS. 9 and 10 show drives (not provided with any further reference signs), i.e. in particular belt drives, by means of which the relocation modules 16.1 of the relocation apparatus 16 and the wrapping bodies 8.1 can be set into corresponding rotational and/or translational movements.

The above-described configuration of the relocation apparatus 16 allows for industrially applicable, high-precision relocation of corresponding blanks 4 and, as a result, high-precision wrapping of corresponding blanks 4, and this results in technically and also economically highly efficient production of conical filter bodies 1.

FIG. 11 is in particular a schematic view of a transfer apparatus 20, a relocation apparatus 16 and a connecting apparatus 8 according to an embodiment in a perspective view of the essential elements. This may show specific embodiments of the transfer apparatus 20, relocation apparatus 16 and connecting apparatus 8 shown in FIG. 6.

FIG. 11 shows a transfer apparatus 20, which is assigned to the separation apparatus 7 and the relocation apparatus 16 and is configured for transferring one or more blanks 4 generated in the separation apparatus 7 from the separation apparatus 7 to the relocation apparatus 16 arranged downstream thereof. In the embodiment, the transfer apparatus 20 may comprise a plurality of block-like or block-shaped transfer bodies 20.1, which each comprise a receiving or mounting region 20.2 for receiving or mounting at least one blank 4. As shown, a corresponding receiving or mounting region 20.2 may be formed by one or more exposed surface portions of a corresponding transfer body 20.1.

As shown by the double-headed arrows P5-P7 by way of example, a corresponding transfer body 20.1 may be mounted so as to be movable on at least one movement path into a first orientation and/or position, which can also be referred to as a receiving orientation and/or position, in which it is possible to receive at least one corresponding blank 4 from the separation apparatus 7, which is not shown in FIG. 11 but is arranged above the transfer apparatus 20, for example at least in portions, and into a second orientation and/or position, which can also be referred to as a passing orientation and/or position, in which it is possible to pass a corresponding blank 4 to the relocation apparatus 16, i.e. in particular to a corresponding relocation module 16.1 of the relocation apparatus 16. A blank 4 held by means of a corresponding transfer body 20.1 can therefore be passed to a corresponding relocation module 16.1 of the relocation apparatus 16 in the passing orientation and/or position shown in FIG. 11 for the upper two transfer bodies 20.1. In particular, a blank 4 held by means of a corresponding transfer body 20.1 can be passed along on corresponding bar-like or bar-shaped relocation elements 16.1.1 of a relocation module 16.1 of the relocation apparatus 16 in the passing orientation and/or position. The bar-like or bar-shaped relocation elements 16.1.1 of a relocation module 16.1 can engage in a contoured surface of a corresponding transfer body 20.1 formed by corresponding receiving contours 20.3, such as depressions, in the passing orientation and/or position of the relevant transfer body 20.1, and this makes it possible to pass a corresponding blank 4 particularly securely from a transfer body 20.1 to the relevant relocation module 16.1.

A corresponding transfer body 20.1 may therefore comprise a contoured surface formed by receiving contours 20.3. As shown at the top of FIG. 11 by way of example, the receiving contours 20.3 are arranged and oriented such that, in the passing orientation and/or position of a transfer body 20.1, they align with corresponding bar-like or bar-shaped relocation elements 16.1.1 of a relocation module 16.1 of the relocation apparatus 16, such that said elements can engage in the receiving contours 20.3 of the relevant transfer body 20.1.

The respective drives of the transfer bodies 20.1 and the relocation apparatus 16 can therefore be coordinated with one another, e.g. by synchronisation, such that the receiving contours 20.3 of the transfer bodies 20.1 and a blank 4 held by means of the respective transfer bodies 20.1 are arranged or oriented in the passing orientation and/or position so as to be adjacent to one another or aligned with one another such that the blank 4 can be passed to the relocation module 16.1 of the relocation apparatus 16 at the top.

In the embodiment, as mentioned, the transfer bodies 20.1 may in particular be mounted so as to be movable on a plurality of movement paths or degrees of freedom. As shown by the double-headed arrows P6 and P7, these may be translational degrees of freedom in one or more translations axes and, as shown by the double-headed arrow P5, rotational degrees of freedom in one or more rotational axes. Movements in combined degrees of freedom are conceivable here. In the embodiment, the transfer bodies 20.1 may be moved out of the separation apparatus 7 towards the relocation apparatus 16 in a translational degree of freedom, shown by the double-headed arrow P6, along a translational axis. A rotational movement, shown by the double-headed arrow P5, may be superimposed on this translational movement. The movements can serve to correctly orient a corresponding blank 4 in terms of it being passed to the relocation apparatus 16. In addition, the transfer bodies 20.1 are mounted in another, vertical translation axis, shown by the double-headed arrow P7, for producing stroke movements, for example in order to correctly receive a corresponding blank 4 in the separation apparatus 7.

It should also be mentioned here that respective movement paths for moving the transfer bodies 20.1 from the first orientation and/or position into the second orientation and/or position may be identical to or different from movements of the transfer bodies 20.1 from the second orientation and/or position into the first orientation and/or position.

The transfer bodies 20.1 comprise one or more flow ducts (not shown), which communicate with a flow-generating apparatus generating a flow, in particular a suction flow, and open into flow openings (not shown), via which it is possible to pneumatically hold a corresponding blank 4 at least temporarily during a movement of the transfer bodies 20.1 from the first orientation and/or position into the second orientation and/or position. In order to detach the blank 4 from the transfer body 20.1 in connection with passing a corresponding blank 4 from a transfer body 20.1 to the relocation apparatus 16, the or an additional flow-generating apparatus can be configured to generate a blowing flow, as required. The blowing flow can be implemented by a jet of compressed air, for example.

FIG. 11 shows that a corresponding transfer apparatus 20 may comprise a plurality of transfer bodies 20.1. Specifically, the exemplary configuration according to FIG. 11 shows that a plurality of first transfer bodies 20.1 (at the bottom) arranged in pairs can be oriented and/or positioned to receive one or more blanks 4 from the separation apparatus 7, and a plurality of second transfer bodies 20.1 (at the top) arranged in pairs can simultaneously be oriented and/or positioned to pass one or more blanks 4 to the relocation apparatus 4.

FIG. 11 also shows, purely schematically, a stabilising apparatus 21 assigned to the connecting apparatus 8, i.e. to a wrapping apparatus, for stabilising a corresponding blank 4 during a wrapping process. A corresponding stabilising apparatus 21 is therefore configured in particular for generating forces stabilising a corresponding blank 4 during a wrapping process on a conical wrapping body 8.1; here, these are typically forces acting radially relative to the axis of symmetry of the conical wrapping body 8.1. Corresponding forces ensure that a corresponding blank 4 lies on a corresponding conical wrapping body 8.1 as desired and, associated therewith, ensures a desired geometry or volume of the conical filter body 1 that has been produced or is to be produced.

A corresponding stabilising apparatus 20 may be designed as or comprise a pressure apparatus which comprises at least one, e.g. plate-like or plate-shaped, pressure element 20.1. The at least one pressure element 20.1 may be arranged or oriented in parallel with the conically tapering outer geometry of the relevant conical wrapping body 8.1 and, as shown by the double-headed arrow P8, may be movable into at least one pressure position, in which it makes it possible to press a corresponding blank against the conical wrapping body 8.1. Specifically, for this purpose, a corresponding pressure element 20.1 may be mounted so as to be movable in at least one translational and/or rotational degree of freedom. A corresponding pressure position can be maintained by further movements of the pressure element 20.1 during the wrapping process, such that it is ensured that the pressure element 20.1 lies on the blank 4 throughout the entire wrapping process.

Movements of the at least one pressure element 20.1 may be synchronised with movements of the corresponding relocation module 16.1 and/or movements of the conical wrapping body 8.1, in order to make it possible to press against a corresponding blank 4 immediately after receiving the blank 4 in the receiving contour 8.1.1 of the corresponding conical wrapping body 8.

A filter body 1 shown in FIG. 4 can be used to implement a method for producing a filter 14 for a smokable product, such as a cannabis cigarette, which is commonly referred to as a “joint”. The method comprises the steps of:
providing at least one conical filter body 1 which has been produced according to the method described in connection with FIG. 1,
filling the at least one filter body 1 with a filter material 15, in particular an activated carbon material,
closing the at least one filter body 1, in particular by means of closure pieces 19.1, 19.2, which are connected at the ends to the filled filter body 1, e.g. in a form-fitting, force-locked and/or material-bonded manner, and are e.g. made of ceramic or plastics material, to form the filter 14.

The filter 14 that can be produced according to the method is typically a conical filter.

Diverse aspects of the invention are defined by the following clauses:
1. Method for producing a conical filter body (1) for a conical filter of a smokable product, comprising the following steps:
   providing a strip-like or strip-shaped filter body material (3),
   separating at least one blank (4) having a predefined geometry from the strip-like or strip-shaped filter body material (3),
   connecting at least two portions (4.1, 4.2) of the at least one blank (4) to form a conical filter body (1).
2. Method according to clause 1, wherein at least one blank (4) having a curve-like or curved basic shape is separated from the strip-like or strip-shaped filter body material.
3. Method according to clause 1 or 2, wherein at least two portions (4.1, 4.2) of the blank (4) are connected by wrapping the at least one blank (4) around an, in particular conical, wrapping body (8.1).
4. Method according to clause 3, wherein a wrapping body comprising a fixing apparatus (9) is used as part of a wrapping process for, in particular mechanically and/or pneumatically, temporarily fixing the at least one blank (4).
5. Method according to any of the preceding clauses, wherein an adhesive material (10), in particular a glue, is applied to at least portions of the at least one blank (4) before connecting the at least two portions (4.1, 4.2) of the at least one blank (4).
6. Method according to any of the preceding clauses, wherein the strip-like or strip-shaped filter body material (3) is collected in a collection apparatus (12) after the at least one blank (4) has been separated.
7. Method according to any of the preceding clauses, wherein the at least one blank (4) is separated from the strip-like or strip-shaped filter body material (3) by means of a mechanical separation process, in particular a cutting or stamping process, and/or by means of an optical separation process, in particular a laser-cutting process.
8. Method according to any of the preceding clauses, wherein a plurality of blanks (4) are separated from the strip-like or strip-shaped filter body material (3) simultaneously or in succession and are collected in an, e.g. magazine-like or magazine-shaped, collection apparatus (13).
9. Method according to any of the preceding clauses, wherein before separating the at least one blank (4) having a predefined geometry from the strip-like or strip-shaped filter body material (3), the strip-like or strip-shaped filter body material (3) is marked, in particular printed, or
   after separating the at least one blank (4) having a predefined geometry from the strip-like or strip-shaped filter body material, the at least one blank (4) is marked, in particular printed.
10. Method according to any of the preceding clauses, wherein a wrapping apparatus is used as a connecting apparatus (8) which comprises at least one conical wrapping body (8.1) which is mounted so as to be movable in at least two different degrees of freedom.
11. Method according to clause 10, wherein a wrapping apparatus is used as a connecting apparatus (8) which comprises at least one conical wrapping body (8.1) which is mounted so as to be movable in a rotational degree of freedom about the axis of symmetry of the wrapping body (8.1) and in a translational degree of freedom along the axis of symmetry of the wrapping body (8.1) or an axis parallel thereto.
12. Method according to any of clauses 9 to 11, wherein a conical wrapping body (8.1) is used which comprises at least one receiving contour (8.1.1), e.g. formed by a groove, a slot or another cut-out in the wrapping body (8.1), for receiving portions of a blank (4).
13. Method according to any of the preceding clauses, wherein a transfer apparatus (20), configured for transferring one or more blanks (4) generated in the separation apparatus (7) from the separation apparatus (7) to a relocation apparatus (16) arranged downstream thereof, is used which comprises at least one transfer body (20.1) which is mounted so as to be movable in at least one degree of freedom, in particular in a plurality of different degrees of freedom.
14. Method according to clause 13, wherein a transfer apparatus (20) is used which comprises at least one transfer body (20.1) which is mounted so as to be movable in at least one degree of freedom, wherein the at least one transfer body (20.1) is mounted so as to be movable on at least one movement path into a first orientation and/or position in which it is possible to receive at least one corresponding blank (4) from the separation apparatus (7) and into a second orientation and/or position in which it is possible to pass a corresponding blank (4) to the relocation apparatus (16).
15. Method according to clause 14, wherein a transfer body (20.1) is used which comprises a contoured surface formed by receiving contours (20.3), wherein the receiving contours (20.3) are arranged and oriented such that, in the second orientation and/or position of the transfer body (20.1), they align with bar-like or bar-shaped relocation elements (16.1.1) of a relocation module (16.1) of a relocation apparatus (16), such that said elements can engage in the receiving contours (20.3) of the transfer body (20.1).
16. Method according to clause 14 or 15, wherein a transfer body (20.1) is used which comprises one or more flow ducts, which communicate with a flow-generating apparatus generating a flow, in particular a suction flow, and open into flow openings.
17. Method according to any of the preceding clauses, wherein a relocation apparatus (16), configured to relocate at least one blank (4) to the connecting apparatus (8) and in particular arranged downstream of a corresponding transfer apparatus (20), is used which comprises at least one relocation module (16.1) which is mounted so as to be movable in at least one degree of freedom.
18. Method according to clause 17, wherein a relocation apparatus (16) is used which comprises at least one relocation module (16.1) which is mounted so as to be movable in at least one degree of freedom and is mounted so as to be movable on at least one movement path into a first orientation and/or position in which it is possible to receive at least one blank (4) from the separation apparatus (7) and/or a conveying apparatus arranged downstream thereof and into a second orientation and/or position in which it is possible to pass a blank (4) to a connecting apparatus (8) designed as a wrapping apparatus.
19. Method according to clause 18, wherein the at least one relocation module (16.1) is moved in a pivoting degree of freedom.
20. Method according to clause 18 or 19, wherein a blank (4) held by means of the at least one relocation module (16.1) is passed to a conical wrapping body (8.1) of the wrapping apparatus in the second orientation and/or position.
21. Method according to any of clauses 18 to 20, wherein a relocation module (16.1) is used which comprises a plurality of relocation elements (16.1.1), which each have a bar-like or bar-shaped geometry.
22. Method according to clause 21, wherein a relocation module (16.1) is used which comprises a plurality of relocation elements (16.1.1), which each have a bar-like or bar-shaped geometry, wherein the relocation elements (16.1.1) are arranged to be adjacent in order to form an, in particular rake-like or rake-shaped, rest or support structure for a corresponding blank (4).
23. Method according to clause 22, wherein a relocation module (16.1) is used which comprises a plurality of relocation elements (16.1.1), which are arranged on a base structure (16.2) of the relocation module (16), wherein first relocation elements (16.1.1) are arranged in a first spatial plane on the base structure (16.2) and second relocation elements (16.1.1) are arranged in a second spatial plane on the base structure (16.2).
24. Method according to any of clauses 21 to 23, wherein a relocation module (16.1) is used which comprises a plurality of relocation elements (16.1.1), which comprise one or more flow ducts, which communicate with a flow-generating apparatus generating a suction flow and open into flow openings.
25. Method according to any of the preceding clauses, wherein a stabilising apparatus (21) configured for stabilising a blank (4) during a wrapping process is used.
26. Method according to clause 25, wherein a stabilising apparatus (21) designed as a pressure apparatus is used which comprises at least one, e.g. plate-like or plate-shaped, pressure element which is movable into at least one pressure position.
27. Filter body (1), which is produced according to the method according to any of the preceding clauses.
28. Device (6) for producing a conical filter body (1) for a conical filter (2) of a smokable product, comprising:
   a provision apparatus (5) for providing a strip-like or strip-shaped filter body material (3),
   a separation apparatus (7) for separating at least one blank (4) having a predefined geometry from the strip-like or strip-shaped filter body material (3),
   a connecting apparatus (8) for connecting at least two portions (4.1, 4.2) of the at least one blank (4) to form a conical filter body (1).
29. Device according to clause 28, wherein the connecting apparatus (8) is designed as a wrapping apparatus or comprises at least one such wrapping apparatus, which comprises at least one conical wrapping body (8.1) which is mounted so as to be movable in at least two different degrees of freedom.
30. Device according to clause 29, wherein the connecting apparatus (8) is designed as a wrapping apparatus or comprises at least one such wrapping apparatus, which comprises at least one conical wrapping body (8.1) which is mounted so as to be movable in a rotational degree of freedom about the axis of symmetry of the wrapping body (8.1) and in a translational degree of freedom along the axis of symmetry of the wrapping body (8.1) or an axis parallel thereto.
31. Device according to clause 29 or 30, wherein a conical wrapping body (8.1) is used which comprises at least one receiving contour (8.1.1), e.g. formed by a groove, a slot or another cut-out in the wrapping body (8.1), for receiving portions of a blank (4).
32. Device according to any of clauses 28 to 31, further comprising a transfer apparatus (20), configured for transferring one or more blanks (4) generated in the separation apparatus (7) from the separation apparatus (7) to a relocation apparatus (16) arranged downstream thereof, which comprises at least one transfer body (20.1) which is mounted so as to be movable in at least one degree of freedom.
33. Device according to clause 32, wherein the transfer apparatus (20) comprises at least one transfer body (20.1) which is mounted so as to be movable in at least one degree of freedom, wherein the at least one transfer body (20.1) is mounted so as to be movable on at least one movement path into a first orientation and/or position in which it is possible to receive at least one corresponding blank (4) from the separation apparatus (7) and into a second orientation and/or position in which it is possible to pass a corresponding blank (4) to the relocation apparatus (16).
34. Device according to clause 33, wherein the transfer body (20.1) comprises a contoured surface formed by receiving contours (20.3), wherein the receiving contours (20.3) are arranged and oriented such that, in the second orientation and/or position of the transfer body (20.1), they align with bar-like or bar-shaped relocation elements (16.1.1) of a relocation module (16.1) of a relocation apparatus (16), such that said elements can engage in the receiving contours (20.3) of the transfer body (20.1).
35. Device according to clause 33 or 34, wherein the transfer body (20.1) comprises one or more flow ducts, which communicate with a flow-generating apparatus generating a flow, in particular a suction flow, and open into flow openings.
36. Device according to any of clauses 28 to 35, characterised by a relocation apparatus (16), configured to relocate at least one blank (4) from the separation apparatus (7) to the connecting apparatus (8), which comprises at least one relocation module (16.1) which is mounted so as to be movable in at least one degree of freedom.
37. Device according to clause 36, wherein the relocation apparatus (16) comprises at least one relocation module (16.1) which is mounted so as to be movable in at least one degree of freedom and is mounted so as to be movable on at least one movement path into a first orientation and/or position in which it is possible to receive at least one blank (4) from the separation apparatus (7) and/or a conveying apparatus arranged downstream thereof and into a second orientation and/or position in which it is possible to pass a blank (4) to a connecting apparatus (8) designed as a wrapping apparatus.
38. Device according to clause 37, wherein the at least one relocation module (16.1) is movable in a pivoting degree of freedom.
39. Device according to clause 37 or 38, wherein a blank (4) held by means of the at least one relocation module (16.1) is or can be passed to a conical wrapping body (8.1) of the wrapping apparatus in the second orientation and/or position.
40. Device according to any of clauses 37 to 39, wherein the relocation module (16.1) comprises a plurality of relocation elements (16.1.1), which each have a bar-like or bar-shaped geometry.
41. Device according to clause 40, wherein the relocation module (16.1) comprises a plurality of relocation elements (16.1.1), which each have a bar-like or bar-shaped geometry, wherein the relocation elements (16.1.1) are arranged to be adjacent in order to form a rest or support structure for a corresponding blank (4).
42. Device according to clause 41, wherein the relocation elements (16.1.1) are arranged or formed on a base structure (16.2) of the relocation module (16), wherein first relocation elements (16.1.1) are arranged in a first spatial plane on the base structure (16.2) and second relocation elements (16.1.1) are arranged in a second spatial plane on the base structure (16.2).
43. Device according to any of clauses 40 to 42, wherein the relocation elements (16.1.1) comprise one or more flow ducts, which communicate with a flow-generating apparatus generating a suction flow and open into flow openings.
44. Device according to any of clauses 28 to 43, further comprising a stabilising apparatus (21) configured for stabilising a blank (4) during a wrapping process.
45. Method according to clause 44, wherein the stabilising apparatus (21) is designed as a pressure apparatus which comprises at least one, e.g. plate-like or plate-shaped, pressure element which is movable into at least one pressure position.
46. Method for producing a filter (2) for a smokable product, comprising the steps of:
   providing a conical filter body, which is produced according to the method according to any of clauses 1 to 27,
   filling the filter body with a filter material, in particular an activated carbon material,
   closing the filter body (1), in particular by means of closure pieces (19.1, 19.2), to form the filter (2).
47. Filter (2) for a smokable product, which is produced according to the method according to clause 46.

1. A method for producing a conical filter body (1) for a conical filter of a smokable product, characterised by the following steps:
providing a strip-like or strip-shaped filter body material (3),
separating at least one blank (4) having a predefined geometry from the strip-like or strip-shaped filter body material (3),
connecting at least two portions (4.1, 4.2) of the at least one blank (4) to form a conical filter body (1).

2. The method according to claim 1, characterised in that at least one blank (4) having a curved basic shape is separated from the strip-like or strip-shaped filter body material.

3. The method according to any of claim 1, characterised in that the strip-shaped filter body material (3) is collected in a collection apparatus (12) after the at least one blank (4) has been separated.

4. The method according to claim 1, wherein the at least one blank comprises a plurality of blanks, and wherein the plurality of blanks (4) are separated from the strip-shaped filter body material (3) simultaneously or in succession and are collected in a collection apparatus (13).

5. The method according to claim 1, characterised in that a wrapping apparatus is used as a connecting apparatus (8) which comprises at least one conical wrapping body (8.1) which is mounted so as to be movable in at least two different degrees of freedom.

6. The method according to claim 5, characterised in that a wrapping apparatus is used as a connecting apparatus (8) which comprises at least one conical wrapping body (8.1) which is mounted so as to be movable in a rotational degree of freedom about the axis of symmetry of the wrapping body (8.1) and in a translational degree of freedom along the axis of symmetry of the wrapping body (8.1) or an axis parallel thereto.

7. The method according to claim 1, characterised in that a transfer apparatus (20), configured for transferring one or more of the at least one blanks (4) generated in the separation apparatus (7) from the separation apparatus (7) to a relocation apparatus (16) arranged downstream thereof, is used which comprises at least one transfer body (20.1) which is mounted so as to be movable in at least one degree of freedom.

8. The method according to claim 7, characterised in that a transfer apparatus (20) is used which comprises at least one transfer body (20.1) which is mounted so as to be movable in at least one degree of freedom, wherein the at least one transfer body (20.1) is mounted so as to be movable on at least one movement path into a first orientation and/or position in which it is possible to receive one or more of the at least one blank (4) from the separation apparatus (7) and into a second orientation and/or position in which it is possible to pass a corresponding blank (4) to the relocation apparatus (16).

9. The method according to claim 1, characterised in that a relocation apparatus (16), configured to relocate the at least one blank (4) to the connecting apparatus (8) downstream of a corresponding transfer apparatus (20), is used which comprises at least one relocation module (16.1) which is mounted so as to be movable in at least one degree of freedom.

10. The method according to claim 9, characterised in that a relocation apparatus (16) is used which comprises at least one relocation module (16.1) which is mounted so as to be movable in at least one degree of freedom and is mounted so as to be movable on at least one movement path into a first orientation and/or position in which it is possible to receive the at least one blank (4) from the separation apparatus (7) and/or a conveying apparatus arranged downstream thereof and into a second orientation and/or position in which it is possible to pass a blank (4) to a connecting apparatus (8) designed as a wrapping apparatus, wherein the at least one relocation module (16.1) is particularly moved in a pivoting degree of freedom.

11. The method according to claim 1, characterised in that a stabilising apparatus (21) configured for stabilising a blank (4) during a wrapping process is used, wherein the stabilising apparatus (21) is designed as a pressure apparatus is used which comprises at least one pressure element which is movable into at least one pressure position.

12. A device (6) for producing a conical filter body (1) for a conical filter (2) of a smokable product, comprising:
a provision apparatus (5) for providing a strip-like or strip-shaped filter body material (3),
a separation apparatus (7) for separating at least one blank (4) having a predefined geometry from the strip-like or strip-shaped filter body material (3),
a connecting apparatus (8) for connecting at least two portions (4.1, 4.2) of the at least one blank (4) to form a conical filter body (1).

13. The device according to claim 12, characterised in that the connecting apparatus (8) is designed as a wrapping apparatus or comprises at least one such wrapping apparatus, which comprises at least one conical wrapping body (8.1) which is mounted so as to be movable in at least two different degrees of freedom.

14. The device according to claim 13, characterised in that the connecting apparatus (8) is designed as a wrapping apparatus or comprises at least one such wrapping apparatus, which comprises at least one conical wrapping body (8.1) which is mounted so as to be movable in a rotational degree of freedom about the axis of symmetry of the wrapping body (8.1) and in a translational degree of freedom along the axis of symmetry of the wrapping body (8.1) or an axis parallel thereto.

15. The device according to claim 12, characterised by a transfer apparatus (20), configured for transferring the one or more blank (4) generated in the separation apparatus (7) from the separation apparatus (7) to a relocation apparatus (16) arranged downstream thereof, which comprises at least one transfer body (20.1) which is mounted so as to be movable in at least one degree of freedom.

16. The device according to claim 15, characterised in that the transfer apparatus (20) comprises at least one transfer body (20.1) which is mounted so as to be movable in at least one degree of freedom, wherein the at least one transfer body (20.1) is mounted so as to be movable on at least one movement path into a first orientation and/or position in which it is possible to receive one or more of the at least one blank (4) from the separation apparatus (7) and into a second orientation and/or position in which it is possible to pass a corresponding blank (4) to the relocation apparatus (16).

17. The device according to claim 12, characterised by a relocation apparatus (16), configured to relocate the at least one blank (4) from the separation apparatus (7) to the connecting apparatus (8), which comprises at least one relocation module (16.1) which is mounted so as to be movable in at least one degree of freedom.

18. The device according to claim 17, characterised in that the relocation apparatus (16) comprises at least one relocation module (16.1) which is mounted so as to be movable in at least one degree of freedom and is mounted so as to be movable on at least one movement path into a first orientation and/or position in which it is possible to receive the at least one blank (4) from the separation apparatus (7) and/or a conveying apparatus arranged downstream thereof and into a second orientation and/or position in which it is possible to pass a blank (4) to a connecting apparatus (8) designed as a wrapping apparatus, the at least one relocation module (16.1) is particularly movable in a pivoting degree of freedom.

19. The device according to claim 12, characterised by a stabilising apparatus (21) configured for stabilising a blank (4) during a wrapping process, wherein the stabilising apparatus (21) is designed as a pressure apparatus which comprises at least one pressure element which is movable into at least one pressure position.

20. A method for producing a filter (2) for a smokable product, characterised by the steps of:
providing a conical filter body, which is produced according to the method according to claim 1,
filling the filter body with a filter material, in particular an activated carbon material,
closing the filter body (1), in particular by means of closure pieces (19.1, 19.2), to form the filter (2).
